(19) United States
(12) Patent Application Publication
(10) Pub. No.: US 2024/0065222 A1
(43) Pub. Date: Feb. 29, 2024

(54) Pet cooling and heating tile

(71) Applicant: Mike O' Meara, Houston, TX (US)

(72) Inventor: Mike O' Meara, Houston, TX (US)

(21) Appl. No.: 18/238,500

(22) Filed: Aug. 27, 2023

Related U.S. Application Data
(60) Provisional application No. 63/401,689, filed on Aug. 28, 2022.

(51) Int. Cl. A01K 1/015; A01K 29/00; F25B 21/04

(52) U.S. Cl. CPC A01K 1/0158; A01K 29/005; F25B 21/04; A01K 1/0353

(57) ABSTRACT

The present invention relates to a pet cooling and heating tile working on Peltier Thermoelectric modules positioned within specific slots. More specifically the invention relates to a bed which makes the pet comfortable and protects them from extreme weather conditions.

### CROSS RELATED APPLICATIONS

This application claims priority from U.S. provisional application No. 63/401,689 filed on 28 Aug. 2022.

### FIELD OF THE INVENTION

The present invention relates to a pet cooling and heating tile. More specifically the invention relates to a bed which makes the pet comfortable and protects them from extreme weather conditions.

### BACKGROUND OF THE RELATED ART

The various pet beds existed in prior arts which maintains the temperature of pet beds favorable for pets.

Few existing prior arts related to the above context include U.S. Patent publication no. US2009084320A1 to Miller Manufacturing Co teaches a pet bed which can transfer heat from a pet to a support structure. The pet bed includes a pad defining an internal chamber, and a batting secured within the pad. The batting allows water within the internal chamber to easily flow there so that heat is transferred away from the pet through convection and conduction.

Another U.S. Pat. No. 8,567,347B2 to Layray LLC. teaches a thermodynamic pet cooling station that uses conductive properties to transfer cold temperatures from a cooling element contained within an insulated base to the surface of a platform tile, creating an efficiently cooled area where an animal may rest when he/she is subjected to dangerously hot weather. To keep the pet cooling station, cool the thermodynamic pet cooling station comprises a molded insulated base, structural platform tiles made from a conductive metal comprised of a planar surface with temperature-transfer cases affixed to their underside, and cooling pods, that can be pre-frozen and are reusable, containing a non-toxic liquid.

Another Korean Patent no. KR101817470B1 teaches a cooling bed for pets comprising a support structure, an accommodation chamber formed on the inside of the outer border part to place a cooling member; and a mat made of marble. The KR101817470B1 teaches the use of an ice pack as a cooling member.

The existing prior arts provide pet cooling beds. And these beds can be maintained at a cool temperature by circulating water within the internal chamber, using pre-frozen and reusable pods which contain a non-toxic liquid or by using ice packs. The present invention provides an improved pet cooling bed where the temperature is maintained with the help of adequately positioned Peltier devices beneath the surface of the Pet bed. More details will be evident in the upcoming sections below.

### SUMMARY OF THE INVENTION

The present invention discloses a pet cooling and heating tile. The disclosed pet cooling tile provides a tile-like surface for the pet to seek comfort during extreme weather conditions when the pet owner is probably at work. The objective of the invention is to provide a solution for pet body temperature regulation, embodying key qualities such as user-friendliness, cost-effectiveness, operational efficiency, reliability, safety, lightweight construction, and durability.

According to an embodiments of the present invention, the pet cooling tile includes a high-density plastic base for structural support and a stainless-steel tile on the upper surface. Beneath the stainless-steel tile surface, multiple thermoelectric modules or Peltier devices are positioned. Peltier devices work on the phenomenon of “Peltier Effect” which is described as the cooling of one junction and the heating of the other when electric current is maintained in a circuit of material consisting of two dissimilar conductors. According to yet another embodiment of the present invention, the pet tile also incorporates a digital temperature sensor and a dedicated controller, which serves as the central processing unit of the system. The stainless-steel upper surface provides a highly conductive layer for efficient heat transfer, while the plastic base maintains lightweight characteristics. According to yet another embodiment of the present invention, for powering the system, a 12V AC to DC adapter is employed. This adapter will not only provide the necessary power for the various components but will also ensure safety for pets and pet parents. To further optimize power supply, a regulator will be utilized to step down the 12V DC to 5V DC, specifically required to power the controller.

### BRIEF DESCRIPTION OF THE ACCOMPANYING DRAWINGS

The accompanying drawing illustrates the present invention and, together with the description, explain the principles of the invention according to the embodiments. One skilled in the art will recognize that the particular embodiments illustrated in the drawings are merely exemplary and are not intended to limit the scope of the present invention.

FIG. 1 illustrates a top perspective view of an embodiment of the pet cooling and heating tile.

FIG. 2 is the bottom plan view of an embodiment of the pet cooling and heating tile.

FIG. 3 is an exploded side view of an embodiment of the pet cooling and heating tile.

FIG. 4 is the side view of an embodiment of the pet cooling and heating tile.

FIG. 5 depicts an exploded top perspective view of an embodiment of the pet cooling and heating tile.

### DETAILED DESCRIPTION OF THE RELATED ART

The embodiments herein and the various features and advantageous details thereof are explained with reference to the non-limiting example in the following description. The example used herein is intended merely to facilitate an understanding of how the embodiments herein may be practiced and to further enable those of skill in the art to practice the embodiments herein.

Unless otherwise defined, all terms (including technical and scientific terms) used herein have the same meaning as commonly understood by one of the ordinary skills in the art of this disclosure. It will be further understood that terms, such as those defined in commonly used dictionaries, should be interpreted as having a consistent meaning in the context of the specification and should not be interpreted in an idealized or overly formal sense unless expressly so defined herein. Well-known functions or constructions may not be described in detail for brevity or clarity.

A pet cooling and heating tile according to embodiments of the present invention is characterized to provide a bed for pets to protect them from extreme weather conditions. According to the present invention, the pet cooling and heating tile is a durable, safe, cost-effective and pet comfort tile.

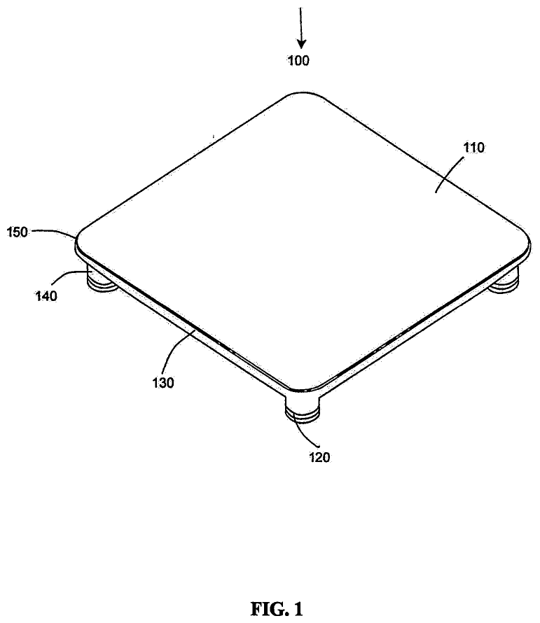

FIG. 1 illustrates a top perspective view of a representative embodiment of the present innovation. The innovative pet cooling and heating tile (100), comprises a stainless-steel tile (110) situated at top and a carefully designed high-density plastic base (130) meticulously engineered for enduring structural integrity. The selection of high-density plastic material is versatile and may be selected from options such as High-Density Polyethylene (HDPE), Polypropylene (PP), Polyethylene Terephthalate (PET), Polycarbonate (PC), Polyvinyl Chloride (PVC), among others. The base is equipped with strategically positioned specialized slots (140), to accommodate screw pegs (120) that contribute significantly to maintaining the pet tile's specific elevation above ground level. The screw peg slots protrusion from the main frame of the Pet Tile extends by 0.5 inch or can vary based on specific requirements. The threaded insertion of these screw pegs (120) into their corresponding slots (140) ensures a robust and dependable attachment mechanism for the entirety of the assembly.

Notably, the pet tile has rounded corners (150), a thoughtful design feature aimed at preventing any potential injuries to both pets' and pet parents' legs. The top stain-less steel surface (110) can be applied with visually pleasing decals, catering to diverse aesthetic preferences.

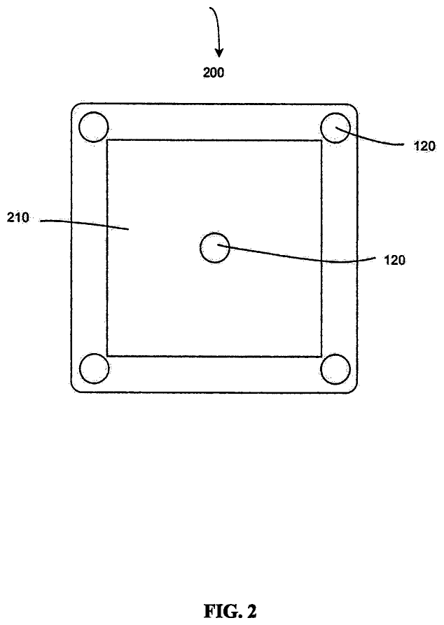

FIG. 2 illustrates the bottom plan view (200) of an embodiment of the pet cooling and heating tile. This depiction showcases strategically positioned slots designed to accommodate screw pegs (120), serving both to elevate the pet tile above ground level and secure it firmly. A protective back plate (210) made of high-density plastic is positioned at the rear, ensuring the secure enclosure of internal components while fortifying the system's structural integrity.

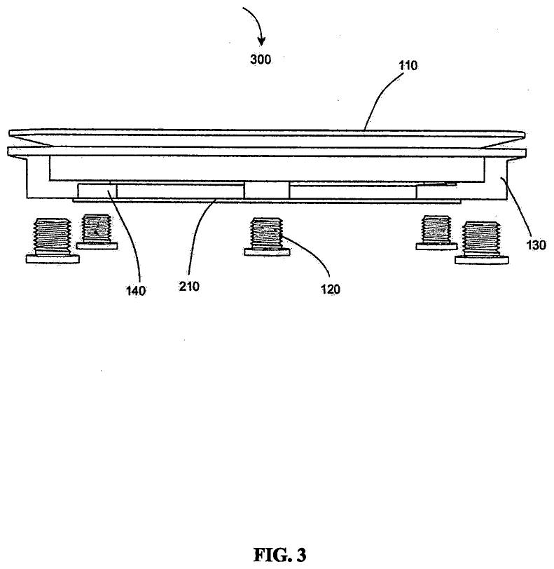

FIG. 3 illustrates exploded side view, shows the structural components of the pet cooling and heating tile. The stainless-steel frame (110), chosen for its thermal properties and durability, is securely affixed at the uppermost position through the use of screw pegs (120). These screw pegs (120) are positioned to align with the slots (140) running widthwise across the tile, securing the stainless-steel plate (110), the middle frame (130) and the back plate (210) together.

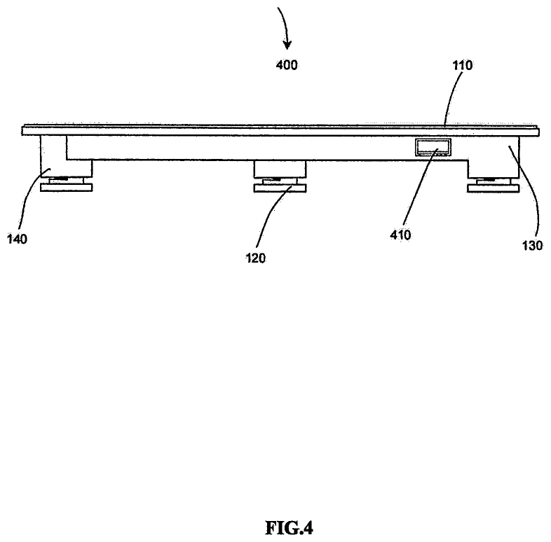

FIG. 4 presents a side view of the pet cooling and heating tile. A designated power slot (410) is provided to accommodate a power plug. This slot serves as the point of connection for the power cord, which provides essential electrical power to the integrated electronics. The power cord is detachable for its convenient removal, for the purpose of relocating the pet tile or making any other necessary adjustments.

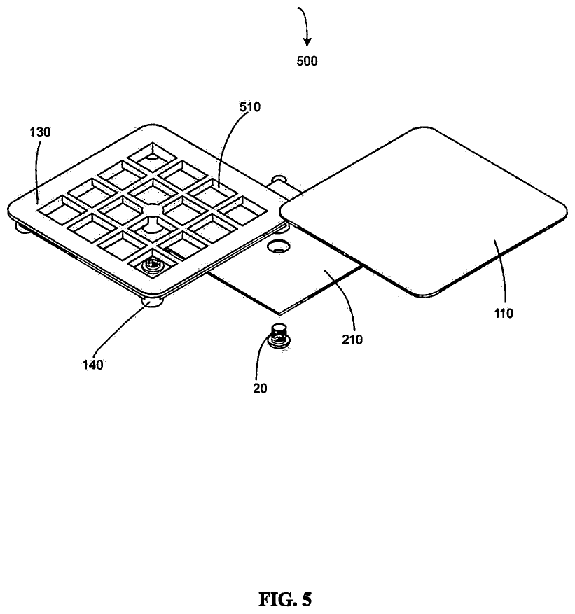

FIG. 5 presents an exploded top perspective view, providing a comprehensive visual breakdown of the pet tile's key components and their arrangement. This view showcases the top stainless-steel frame (110), the middle base frame (130), and the back plate (120), each contributing to the tile's structure and functionality. Across the middle base frame (130) slots (510) are provided for the placement of Peltier devices. These thermoelectric semiconductor components serve as a fundamental element for achieving temperature control without moving parts. Peltier modules, or thermoelectric modules, exhibit dual “warming” and “cooling” effects through the passage of an electric current. This feature facilitates surface temperature manipulation, allowing precise regulation to meet the desired target temperature. Employing Peltier devices for temperature regulation offers numerous advantages, including cost-effectiveness, reliable performance, and safety. The compact dimensions of the Peltier devices, further optimize their integration within the pet cooling tile's design.

A temperature sensor is provided in the pet tile for measuring the pet's body temperature and transmitting this data to a dedicated controller. This controller, processes the temperature data received from the sensor. Based on the information from the sensor, the controller issues commands to the Peltier devices, for the precise heating or cooling actions required to maintain an optimal and comfortable temperature for the pet.

To energize the sensor, Peltier device, controller, and other auxiliary components, a power source of 12 volts is provided. This 12-volt power supply ensures the pet tile's safety for both pets and pet parents. Furthermore, this configuration enhances the power efficiency and economic viability of the pet tile's operation. Additionally, a power regulator can be incorporated to reduce the supplied 12-volt DC from the aforementioned power adapter to 5 volts DC. This regulated 5-volt power supply is essential for powering the controller.

In an embodiment of the invention, for a unified design strategy the pet tile is made as a singular unit, measuring 2.5 ft.×2.5 ft. This design choice enhances the feasibility and cost-effectiveness. Alternatively, a multi-tile system with varying dimensions is also possible with supplementary slave tiles.

While a number of preferred embodiments have been described, it will be appreciated by a person skilled in the art that numerous variations and/or modifications may be made in the invention without departing from the spirit or scope of the invention as broadly described. The present embodiments are, therefore, to be considered in all respects as illustrative and not restrictive.

What is claimed is:

1. A pet cooling and heating tile comprising:
a. a stainless steel top;
b. a middle frame with slots for the placement of peltier devices;
c. a high density plastic base;
d. a high density base equipped with strategically positioned slots to accommodate screw pegs;
e. a protective back plate made of high-density plastic positioned at the base, ensuring the secured enclosure of internal components;
f. a designated power slot to accommodate a power plug;
g. a temperature sensor to measure the body temperature of the pet;
h. a controller to regulate heating or cooling of the peltier devices.

2. A pet tile according to claim 1, wherein the peltier devices positioned in the slots of middle frame exhibit dual warning and cooling effects through the passage of electric current and thereby regulate the surface temperature of the tile based on the temperature of the pet.

3. A pet tile according to claim 1, wherein the temperature sensor will measure the temperature of the pet and feed the temperature data to the controller.

4. A pet tile according to claim 3, wherein the controller after receiving the temperature data of the pet from the temperature sensor; will regulate the cooling or heating of the pet tile.

5. A pet tile according to claim 3, wherein the tile will become cooler during summer and warmer during winter based on the surface body temperature of the pet.

6. A pet tile according to claim 1, wherein the protective back plate could be made up of a variety of high density plastic including but not limited to High-Density Polyethylene (HDPE), Polypropylene (PP), Polyethylene Terephthalate (PET), Polycarbonate (PC), Polyvinyl Chloride (PVC), among others.

7. A pet tile according to claim 1, wherein for powering the pet tile, a 12V AC to DC adapter is employed, further to optimize power supply, a regulator will be utilized to step down the 12V DC to 5V DC, specifically required to power the controller.

8. A pet tile according to claim 1, wherein the base is equipped with strategically positioned specialized slots to accommodate screw pegs that contribute significantly to maintain the pet tile's elevation above ground level.

9. A pet tile according to claim 8, wherein threaded insertion of the screw pegs into the special slots ensure a robust and dependable attachment mechanism for the entirety of the assembly.

10. A pet cooling and heating tile comprising slots for the placement of thermoelectric peltier devices or semiconductor modules for temperature regulation and achieving temperature control and exhibit dual warming and cooling effects through the passage of electric current to meet surface temperature requirements of the pet.

11. A pet cooling and heating tile according to claim 10, wherein the tile is safe, cost-effective and imparts reliable performance and safety to the pets.
